(19) United States
(12) Patent Application Publication
(10) Pub. No.: US 2019/0034436 A1
(43) Pub. Date: Jan. 31, 2019

(54) SYSTEMS AND METHODS FOR SEARCHING DOCUMENTS USING AUTOMATED DATA ANALYTICS

(71) Applicant: HARRIS CORPORATION, Melbourne, FL (US)

(72) Inventors: Thomas C. Ottoson, Satellite Beach, FL (US); John Farrell, Melbourne, FL (US); Tom Billhartz, Melbourne, FL (US); William C. Wingate, West Melbourne, FL (US); Mark Rahmes, Melbourne, FL (US)

(21) Appl. No.: 15/663,901

(22) Filed: Jul. 31, 2017

(51) Int. Cl. G06F 17/30

(52) U.S. Cl. CPC G06F 17/3069; G06F 17/30707; G06F 17/30011

(57) ABSTRACT

Systems (100) and methods (500) for searching electronic documents. The methods comprise: using first electronic documents to derive topics respectively defined by sets of words; using the topics to transform a format of known subject reviews and written pieces from a textual format to a numerical format in which each of the subject reviews and written pieces is expressed as a topic vector containing a plurality of first numbers respectively corresponding to the topics; generating concept vectors by transforming a domain of the topic vectors from a first numerical domain to a second different numerical domain; and determining similarities between the known subject reviews and the written pieces by comparing first concept vectors that are associated with the known subject reviews to second concept vectors concept vectors that are associated with the written pieces.

### FIELD

This document relates generally to computing devices. More particularly, this document relates to systems and methods for searching documents using automated data analytics.

### BACKGROUND

As known, data analytics is a process of examining data sets in order to draw conclusions about the information they contain. Data analytics can be used to enhance productivity and business gain. Techniques for preforming data analytics vary according to organizational requirements.

Machine learning algorithms use computational methods to learn information directly from data without assuming a predetermined equation or relationship as a model. The machine learning algorithms can adaptively improve their performance as the number of samples available for learning increases. In some cases, machine learning algorithms utilize a clustering algorithm to group a set of objects based on their common characteristics, and aggregate them according to their similarities.

### SUMMARY

The present disclosure concerns implementing systems and methods for searching electronic documents. The methods comprise: using a plurality of first electronic documents to derive a plurality of topics respectively defined by sets of words; and using the topics to transform a format of a plurality of known subject reviews and a plurality of written pieces from a textual format to a numerical format in which each of the subject reviews and written pieces is expressed as a topic vector containing a plurality of first numbers. Each first number corresponds to a respective one of the topics. A plurality of concept vectors are then generated by transforming a domain of the topic vectors from a first numerical domain to a second different numerical domain. Similarities between the plurality of known subject reviews and the plurality of written pieces are determined by comparing first concept vectors of the plurality of concept vectors that are associated with the plurality of known subject reviews to second concept vectors of the plurality of concept vectors that are associated with the plurality of written pieces.

In some scenarios, the written pieces are obtained from a plurality of second electronic documents that are the same as or different than the plurality of first electronic documents. Each of the plurality of written pieces can comprise a single paragraph extracted from an electronic document.

In those or other scenarios, the textual format is transformed into the numerical format by: inferring numerical values of similarity between words of the sets of words and words of a known subject review or written piece; and combining the numerical values in accordance with a weighting algorithm. The first numerical domain comprises a topic domain describing individual types of technology and the second different numerical domain comprises a concept domain describing a broader category in which a plurality of technology types are represented. The domain of the topic vectors is transformed using Singular Value Decomposition. The similarities are determined using a cosine similarity algorithm.

In those or yet other scenarios, the methods further involve: determining an accuracy of values representing the similarities; classifying each of the plurality of written pieces based on the determined similarities; and/or modifying at least one electronic document based on results of the classifying.

### DETAILED DESCRIPTION OF THE DRAWINGS

The present solution will be described with reference to the following drawing figures, in which like numerals represent like items throughout the figures.

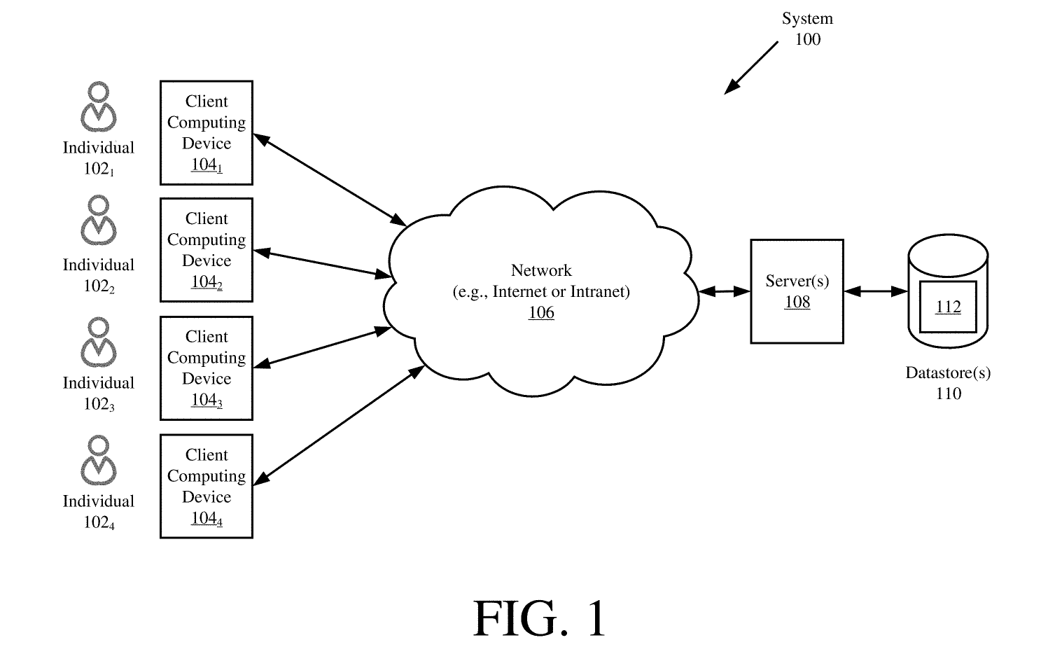

FIG. 1 is an illustration of an illustrative system.

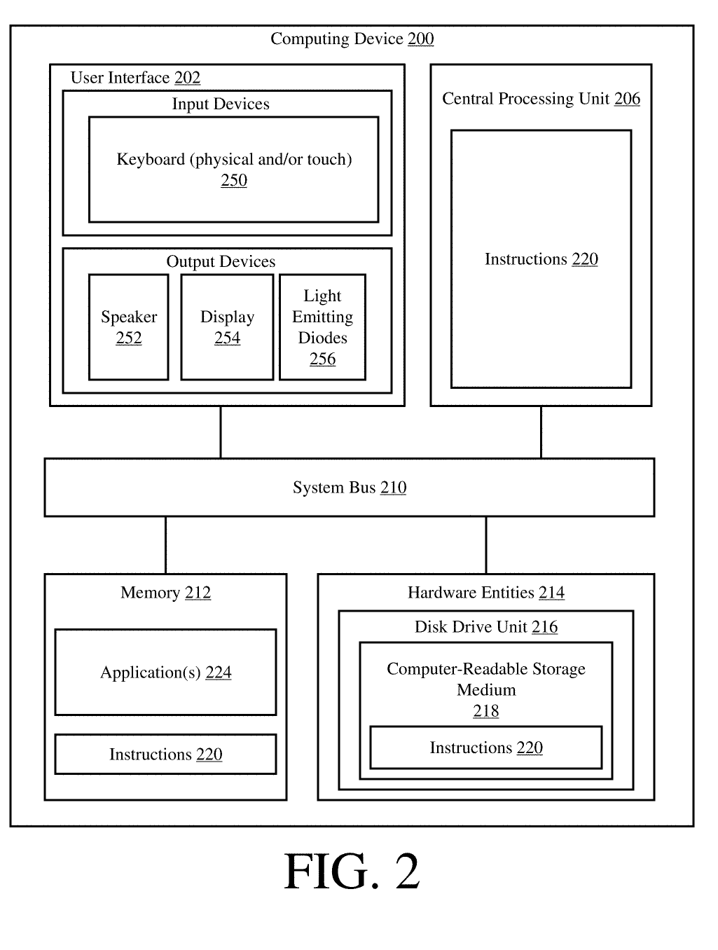

FIG. 2 is an illustration of an illustrative computing device.

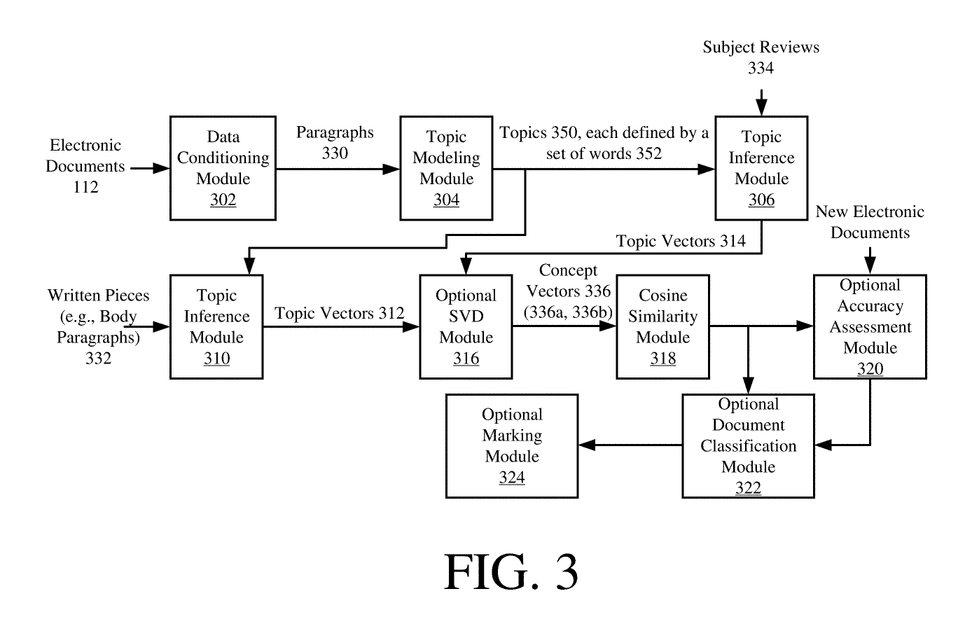

FIG. 3 is an illustration that is useful for understanding an illustrative method for searching documents using automated data analytics in accordance with the present solution.

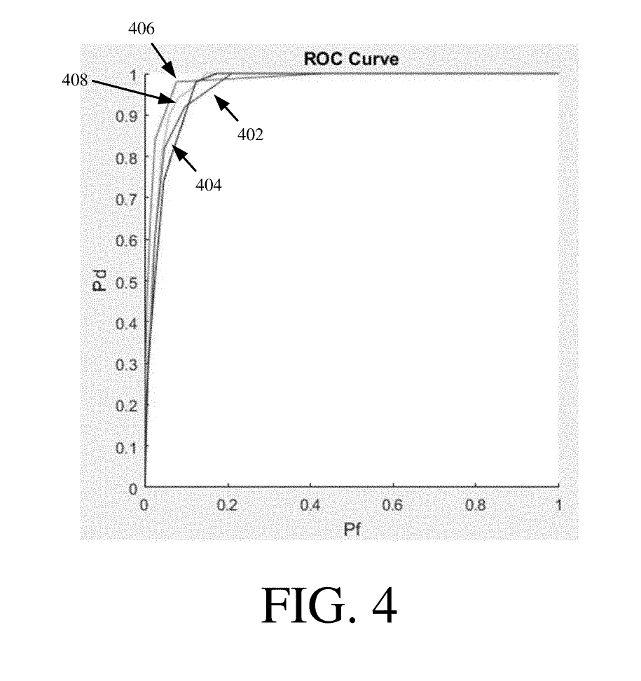

FIG. 4 is a graph showing an illustrative Receiver Operating Characteristics (“ROC”) curve.

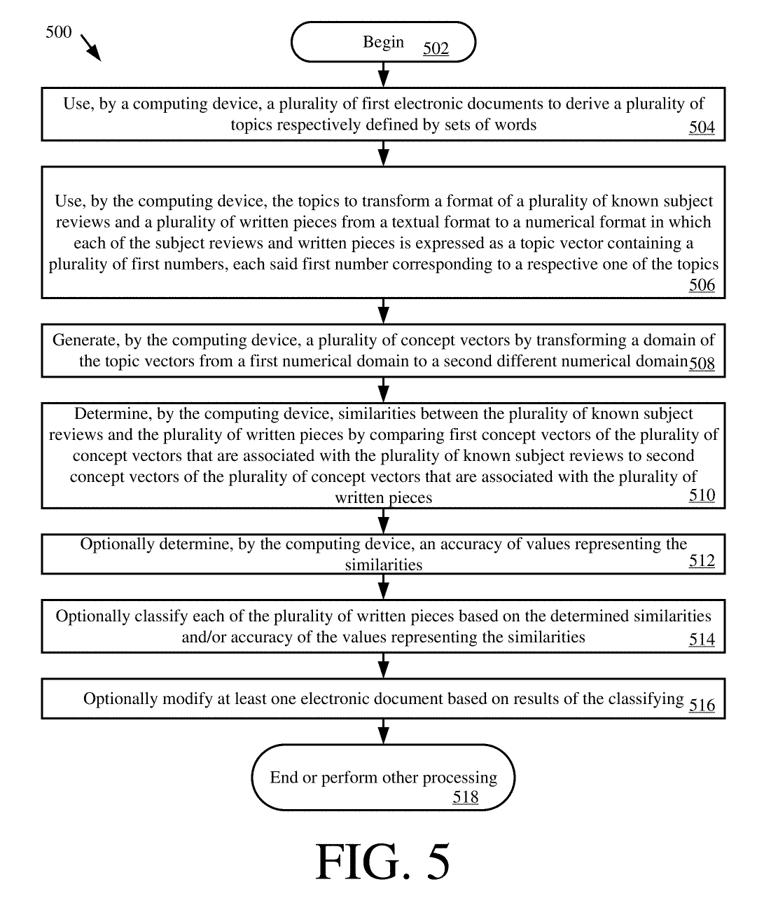

FIG. 5 is a flow diagram of an illustrative method for searching electronic documents.

### DETAILED DESCRIPTION

It will be readily understood that the components of the present solution as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the present solution are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present disclosure concerns systems and methods for searching documents using automated data analytics. The present solution provides a scalable, modular enterprise tool which adds topics as a searchable field to identify similar text on a per written piece (e.g., paragraph) basis. The search can also be used to identify threat or high value descriptions.

The present solution generally involves: obtaining a plurality of electronic documents to be processed from at least one datastore; performing data conditioning to extract distinct sections (e.g., paragraphs) from the electronic documents; inputting the distinct sections (e.g., paragraphs) into a topic modeler; analyzing the distinct sections (e.g., paragraphs) to derive (a) a plurality of topics covered by the documents and (b) a set of words defining each of the topics; using the derived sets of words to transform the text of each distinct section (e.g., full document or paragraph) into a topic vector comprising a plurality of numbers indicating the amount of similarity between the text and the sets of words; comparing each topic vector to a plurality of reference topic vectors; and determining a class for each topic content vector based on results of the comparing.

The present solution can be used in a variety of applications. For example, the present solution can be used to identify electronic documents which are not marked or improperly marked with an importance level designation (e.g., top secret, secret, confidential, classified, unclassified, intellectual property, attorney work product, etc.) or other indicator of the controls on the documents (e.g., HIPPA data). Information and Data Rights Management (“IRM/DRM”) tools are only effective if data is labeled and marked accurately. As such, the present solution provides an improved IRM/DRM tool. The present solution can also be used for data discovery to determine where electronic documents containing proprietary information are stored, who created the electronic documents, who has accessed the electronic documents, when the electronic documents were shared, and to whom the electronic documents were shared. Compartmented networks need a tool to discover data spillage from a high system to a lower system without compromising data. Information security needs a tool to discover if a document without markings contains sensitive material. The present solution provided such tools.

Referring now to FIG. 1, there is provided an illustration of an illustrative system 100. System 100 comprises client computing devices 104₁-104₄, a network 106, at least one server 108 and at least one datastore 110. The client computing devices 104₁-104₄ include, but are not limited to, a personal computer, a laptop computer, a desktop computer, a tablet computer, a notebook computer, a personal digital assistant, a mobile phone and/or a smart phone.

During operation, individuals 102₁-102₄ create electronic documents 112 using the client computing devices 104₁-104₄. The electronic documents include, but are not limited to, any electronic media content (other than computer programs) that are intended to be used in either electronic form or as printed outputs. The electronic documents can be in the same or different file formats, such as a word processor file format, a spread sheet file format, a graphics software file format, or other file viewer format (e.g., Adobe's Acrobat Reader file format and/or a PDF file format).

The electronic documents 112 are then communicated over network 106 to the server(s) 108 for storage in the datastore(s) 110. Network 106 can include, but is not limited to, the Internet and/or an Intranet. Datastore(s) 110 can include, but is not limited to, a database.

The server(s) 108 implement the present solution. In this regard, the server(s) 108 are configured to search the electronic documents 112 using automated data analytics. The document searching is achieved using a scalable, modular enterprise tool which adds topics as a searchable field to identify similar text on a per written piece (e.g., paragraph(s)) basis. The search can also be used to identify threat or high value descriptions.

Referring now to FIG. 2, there is provided an illustration of an exemplary architecture for a computing device 200. Computing devices 104₁-104₄ and server(s) 108 of FIG. 1 (is)are the same as or similar to computing device 200. As such, the discussion of computing device 200 is sufficient for understanding these components of system 100.

In some scenarios, the present solution is used in a client-server architecture. Accordingly, the computing device architecture shown in FIG. 2 is sufficient for understanding the particulars of client computing devices and servers.

Computing device 200 may include more or less components than those shown in FIG. 2. However, the components shown are sufficient to disclose an illustrative solution implementing the present solution. The hardware architecture of FIG. 2 represents one implementation of a representative computing device configured to enable electronic document searching using automated data analytics as described herein. As such, the computing device 200 of FIG. 2 implements at least a portion of the method(s) described herein.

Some or all the components of the computing device 200 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 2, the computing device 200 comprises a user interface 202, a Central Processing Unit (“CPU”) 206, a system bus 210, a memory 212 connected to and accessible by other portions of computing device 200 through system bus 210, and hardware entities 214 connected to system bus 210. The user interface can include input devices and output devices, which facilitate user-software interactions for controlling operations of the computing device 200. The input devices include, but are not limited, a physical and/or touch keyboard 250. The input devices can be connected to the computing device 200 via a wired or wireless connection (e.g., a Bluetooth® connection). The output devices include, but are not limited to, a speaker 252, a display 254, and/or light emitting diodes 256.

At least some of the hardware entities 214 perform actions involving access to and use of memory 212, which can be a Radom Access Memory (“RAM”), a disk driver and/or a Compact Disc Read Only Memory (“CD-ROM”). Hardware entities 214 can include a disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the computing device 200. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 220 for execution by the computing device 200 and that cause the computing device 200 to perform any one or more of the methodologies of the present disclosure.

In some scenarios, the hardware entities 214 include an electronic circuit (e.g., a processor) programmed for facilitating content sharing amongst users. In this regard, it should be understood that the electronic circuit can access and run application(s) 224 installed on the computing device 200. The functions of the software application(s) 224 are apparent from the above discussion of the present solution. For example, the software application is configured to perform one or more of the operations described below in relation to FIGS. 3-5.

Referring now to FIG. 3, there is provided an illustration that is useful for understanding an illustrative method for searching electronic documents using automated data analytics in accordance with the present solution. The illustration comprises a data conditioning module 302, a topic modeling module 304, topic inference modules 306, 310, an optional Singular Value Decomposition (“SVD”) module 316, a cosine similarity module 318, an optional accuracy assessment module 320, an optional document classification module 322, and an optional marking module 324. Each of the modules is implemented via hardware, software or a combination thereof.

During operations, electronic documents 112 (e.g., 50 conference papers, patent applications, white papers, technical descriptions, etc.) are retrieved from one or more datastores (e.g., database 110 of FIG. 1) and provided as inputs to the data conditioning module 302. The data conditioning module 302 processes the electronic documents 112 to extract paragraphs 330 therefrom (e.g., 1500 paragraphs). The present solution is not limited in this regard. Other types of data conditioning can be used. For example, in other scenarios, entire articles, messages, and/or papers are extracted from larger documents.

The extracted paragraphs 330 are then forwarded to the topic modeling module 304. The paragraphs 330 may be forwarded in a serial manner and/or a parallel manner. The paragraphs 330 may be communicated in any order.

The topic modeling module 304 employs an open source topic modeling tool to determine the top N topics 350 that are covered by the contents of the paragraphs 330, where N is an integer (e.g., 200). Topic modeling tools are well known in the art, and therefore will not be described in detail herein. Briefly, topic modeling tools provide a simple way to analyze large volumes of unlabeled text to derive topics covered thereby. Each topic is defined by a set of words 352 (e.g., 10 words) that frequently occur together. Using contextual clues, topic modeling tools connect words with similar meanings and distinguish between uses of words with multiple meanings. Any known or to be known topic modeling tool can be used here without limitation. In some scenarios, the topic modeling module 304 employs the topic modeling tool known as Mallet which is provided by the University of Massachusetts and accessible at http://mallet.cs.umass.edu. Mallet is configured to infer topics from new electronic documents given trained models.

The topics 350 are then communicated to the topic inference modules 306, 310. Written pieces (e.g., body paragraphs) 332 are provided as inputs to the topic inference module 310. The written pieces 332 can each include an entire electronic document or a distinct section of an electronic document. These electronic documents can include electronic documents 112 or other electronic documents (e.g., conference papers, patent applications, white papers, technical descriptions, emails, letters, papers, facsimiles, etc.) contained in a corpus of data.

Subject reviews 334 are provided as inputs to the topic inference module 306. The subject reviews may be contained in the electronic documents 112. Notably, the subject reviews 334 are used here as keys of known data for facilitating a determination as to which topic each written piece in the corpus of data is more closely associated, a determination as to which electronic document each paragraph belongs, and/or a determination as to which written piece contains content disclosed by the keys. The subject reviews can include, but are not limited to, abstracts, overviews, summaries, conclusions, and/or other known written descriptions of subjects. The subject reviews can comprise a single paragraph, more than one paragraph, or an entire electronic document.

Each topic inference module 306, 310 transforms the text of each input 332, 334 into a topic vector 312, 314 containing a plurality of numbers (e.g., 200). Each number contained in a topic vector corresponds to a respective one of the topics 350. Thus, if there are 200 topics, then each topic vector includes 200 values. Each number contained in a topic vector comprises a similarity value. The topic vector is obtained by: comparing each input (e.g., written piece or subject review) to each set of words 352 defining the N topics 350; and inferring numerical values of similarity between the words contained in the input (e.g., written piece or subject review) and the sets of words 352 defining each topic. For example, each topic inference module 306, 310 determines the number of times a written piece (e.g., paragraph) or subject review contains each word contained in each set of words 352 defining the topics 350. The numbers determined for each topic (e.g., 10 numbers) are then added together in accordance with a weighting algorithm (e.g., each number is weighted in accordance with the number of words in the paragraph for the given topic).

In some scenarios, each topic inference module 306, 310 uses the topics 350 as features. A probability of a subject's use of each topic is determined in accordance with the following Mathematical Equation (1).

$$p ( topic \vert subject ) = {\sum }_{word ∈ topic} p ( topic \vert word ) * p ( word \vert subject ) \qquad ( 1 )$$

where p(word|subject) is the normalized word use by that subject and p(topic|word) is the probability of the topic given the word.

Correlations between the topic vectors 312 and topic vectors 314 are then determined. Techniques for correlating data are well known in the art, and therefore will not be described herein. Any known or to be known data correlation technique(s) can be used herein without limitation. For example, the present solution employs a cosine similarity technique as shown by cosine similarity module 318. Additionally or alternatively, the present solution employs a Euclidean distance technique.

In some scenarios, SVD is employed to enhance the text-topic matching while reducing the amount of data. Accordingly, the topic vectors 312, 314 are optionally communicated to an SVD module 316 prior to the cosine similarity module 318. The SVD module 316 converts the numbers of the topic vectors 312, 314 from a first numerical domain of numbers (e.g., a topic domain describing individual types of technology) into a second numerical domain of numbers (e.g., a concept domain describing a broader category in which a plurality of technology types are represented). For example, each topic vector includes 200 numerical values which are reduced to concept vectors including 100 numerical values. This reduction is achieved by transforming each topic vector to a diagonal form using a unitary matrix. The transformation results is a reduced amount of data and an enhancement in machine learning performance. In some scenarios, the transformation is achieved in accordance with the following Mathematical Equation (2).

A=UDV^{T} (2)

where the columns U and V respectively consist of the left and right singular vectors, and D is a diagonal matric whose diagonal entries are the singular values of vector A. Mathematical Equation (2) is well known in the art, and therefore a detailed description thereof is not provided herein.

The concept vectors 336 are passed to the cosine similarity module 318. The concept vectors 336 include concept vectors 336a corresponding to topic vectors 312 and concept vectors 336b corresponding to topic vectors 314. The cosine similarity module 318 compares each concept vector 336a to each concept vector 336b on a normalized space to determine the cosine of an angle therebetween. The cosine value provides a metric that indicates how similar the two concept vectors 336a and 336b are. For example, when a concept vector 336a for a given written piece (e.g., paragraph) and a concept vector 336b for a given subject review are 100% similar, the cosine of the angle between the corresponding concept vectors is 1. When a written piece (e.g., paragraph) and a subject review are 50% similar, then the cosine of the angle between the corresponding concept vectors is 0. When a written piece (e.g., paragraph) and a subject review have 0% similarity, the cosine of the angle between the corresponding concept vectors is −1. The present solution is not limited to the particulars of this example.

In some scenarios, the cosine similarity module 318 implements the following Mathematical Equations (3) and (4). The cosine of two non-zero vectors are derived using the Euclidean dot product formula.

a·b=∥a∥∥b∥cos θ (3)

Given two vectors of attributes, A and B, the cosine similarity, cos(θ), is represented using a dot product and magnitude as

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

where Aᵢ and Bᵢ are components of vector A and B respectively. The resulting similarity ranges from −1 meaning exactly opposite to 1 meaning exactly the same, with 0 indicating orthogonality (decorrelation) and in-between values indicating intermediate similarity or dissimilarity. For text matching, the attribute vectors A and B are usually the term frequency vectors of the documents. The cosine similarity can be seen as a method of normalizing document length during comparison.

The output cosine values of the cosine similarity module 318 are then optionally used by the accuracy assessment module 320 to determine the accuracy thereof. Accuracy assessment techniques are well known in the art, and therefore will not be described herein. Any known or to be known accuracy assessment technique can be used herein without limitation. In some scenarios, an ROC curve based technique is employed. Illustrative ROC curves are shown in FIG. 4. The ROC curves were generated when the present solution was used with an input of 50 electronic documents each comprising a subject review. The ROC curves include an ROC curve 402 for a cosine similarity mean (when SVD is not employed), an ROC curve 404 for a cosine similarity max (when SVD is not employed), an ROC curve 406 for a cosine similarity mean (when SVD is employed), and an ROC curve 408 for a cosine similarity max (when SVD is employed). The Area Under each ROC curves (“AUC”) reflects the probability that the subject review was correctly associated with its electronic document (with the subject review removed). The ROC curves indicate that an increase in accuracy (e.g., 2%) is obtained when SVD is employed, and that the present solution is a highly accurate (e.g., ≥98% accurate) solution for determining which topic of a plurality of topics is covered in each written piece (e.g., paragraph) of a corpus of data.

In some scenarios, the outputs of the cosine similarity module 318 and/or the accuracy assessment module 320 are used by a document classification module 322 to determine a classification for each written piece (e.g., paragraph) and/or corresponding electronic document. The classification can be a level of importance (e.g., top secret, secret, classified, unclassified, confidential, attorney work product, etc.), a technology classification (e.g., analytics, biometrics, energy, hyperspectral, etc.), and/or a content type classification (e.g., Intellectual Property, proprietary information, etc.).

The classifications are then optionally used by a marking module 324 to mark the written piece (e.g., paragraph) and/or corresponding electronic document in the appropriate manner. For example, an Attorney Work Product designation is added to the header and/or footer of an electronic document based on its corresponding classification(s) determined by the above-described process. Additionally or alternatively, a given paragraph of the electronic document is marked as including proprietary information or intellectual property.

Referring now to FIG. 5, there is provided a flow diagram of an exemplary method 500 for searching electronic documents. Method 500 begins with 502 and continues with 504 where a plurality of first electronic documents (e.g., electronic documents 112 of FIGS. 1 and 3) are used by a computing device (e.g., server 108 of FIG. 1 and/or computing device 200 of FIG. 2) to derive a plurality of topics (e.g., topics 350 of FIG. 3) respectively defined by sets of words (e.g., sets of words 352 of FIG. 3).

Next in 506, the computing device uses the topics to transform a format of a plurality of known subject reviews (e.g., subject reviews 334 of FIG. 3) and a plurality of written pieces (e.g., written pieces 332 of FIG. 3). The written pieces are obtained from a plurality of second electronic documents that are the same as or different than the plurality of first electronic documents. Each of the written pieces can comprise a single paragraph extracted from an electronic document. The format is transformed from a textual format to a numerical format in which each of the subject reviews and written pieces is expressed as a topic vector containing a plurality of first numbers. Each first number corresponds to a respective one of the topics. In some scenarios, the textual format is transformed into the numerical format by: inferring numerical values of similarity between words of the sets of words and words of a known subject review or written piece; and combining the numerical values in accordance with a weighting algorithm.

In 508, the computing device generates a plurality of concept vectors by transforming a domain of the topic vectors from a first numerical domain to a second different numerical domain. In some scenarios, the first numerical domain comprises a topic domain describing individual types of technology and the second different numerical domain comprises a concept domain describing a broader category in which a plurality of technology types are represented. The domain of the topic vectors can be transformed using SVD.

In 510, the computing device determines similarities between the plurality of known subject reviews and the plurality of written pieces by comparing first concept vectors of the plurality of concept vectors that are associated with the plurality of known subject reviews to second concept vectors of the plurality of concept vectors that are associated with the plurality of written pieces. In some scenarios, the similarities are determined using a cosine similarity algorithm. The accuracy of the determined similarities is optionally determined in 512.

In certain applications, method 500 may also comprise additional operations as shown by 514-516. For example, method 500 can also involve: classifying each of the plurality of written pieces based on the determined similarities; and modifying at least one electronic document based on results of the classifying. Subsequently, 518 is performed where method 500 ends or other processing is performed (e.g., return to 504 or 506).

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for searching electronic documents, comprising:
using, by a computing device, a plurality of first electronic documents to derive a plurality of topics respectively defined by sets of words;
using, by the computing device, the topics to transform a format of a plurality of known subject reviews and a plurality of written pieces from a textual format to a numerical format in which each of the subject reviews and written pieces is expressed as a topic vector containing a plurality of first numbers, each said first number corresponding to a respective one of the topics;
generating, by the computing device, a plurality of concept vectors by transforming a domain of the topic vectors from a first numerical domain to a second different numerical domain; and
determining, by the computing device, similarities between the plurality of known subject reviews and the plurality of written pieces by comparing first concept vectors of the plurality of concept vectors that are associated with the plurality of known subject reviews to second concept vectors of the plurality of concept vectors that are associated with the plurality of written pieces.

2. The method according to claim 1, wherein the plurality of written pieces are obtained from a plurality of second electronic documents that are the same as or different than the plurality of first electronic documents.

3. The method according to claim 1, wherein each of the plurality of written pieces comprises a single paragraph extracted from an electronic document.

4. The method according to claim 1, wherein the textual format is transformed into the numerical format by: inferring numerical values of similarity between words of the sets of words and words of a known subject review or written piece; and combining the numerical values in accordance with a weighting algorithm.

5. The method according to claim 1, wherein the first numerical domain comprises a topic domain describing individual types of technology and the second different numerical domain comprises a concept domain describing a broader category in which a plurality of technology types are represented.

6. The method according to claim 1, wherein the domain of the topic vectors is transformed using Singular Value Decomposition.

7. The method according to claim 1, wherein the similarities are determined using a cosine similarity algorithm.

8. The method according to claim 1, further comprising determining, by the computing device, an accuracy of values representing the similarities.

9. The method according to claim 1, further comprising classifying each of the plurality of written pieces based on the determined similarities.

10. The method according to claim 9, further comprising modifying at least one electronic document based on results of the classifying.

11. A system, comprising:
a processor; and
a non-transitory computer-readable storage medium comprising programming instructions that are configured to cause the processor to implement a method for searching electronic documents, wherein the programming instructions comprise instructions to:
use a plurality of first electronic documents to derive a plurality of topics respectively defined by sets of words;
use the topics to transform a format of a plurality of known subject reviews and a plurality of written pieces from a textual format to a numerical format in which each of the subject reviews and written pieces is expressed as a topic vector containing a plurality of first numbers, each said first number corresponding to a respective one of the topics;
generate a plurality of concept vectors by transforming a domain of the topic vectors from a first numerical domain to a second different numerical domain; and
determine similarities between the plurality of known subject reviews and the plurality of written pieces by comparing first concept vectors of the plurality of concept vectors that are associated with the plurality of known subject reviews to second concept vectors of the plurality of concept vectors that are associated with the plurality of written pieces.

12. The system according to claim 11, wherein the plurality of written pieces are obtained from a plurality of second electronic documents that are the same as or different than the plurality of first electronic documents.

13. The system according to claim 11, wherein each of the plurality of written pieces comprises a single paragraph extracted from an electronic document.

14. The system according to claim 11, wherein the textual format is transformed into the numerical format by: inferring numerical values of similarity between words of the sets of words and words of a known subject review or written piece; and combining the numerical values in accordance with a weighting algorithm.

15. The system according to claim 11, wherein the first numerical domain comprises a topic domain describing individual types of technology and the second different numerical domain comprises a concept domain describing a broader category in which a plurality of technology types are represented.

16. The system according to claim 11, wherein the domain of the topic vectors is transformed using Singular Value Decomposition.

17. The system according to claim 11, wherein the similarities are determined using a cosine similarity algorithm.

18. The system according to claim 11, wherein the programming instructions further comprise instructions to determine an accuracy of values representing the similarities.

19. The system according to claim 11, wherein the programming instructions further comprise instructions to classify each of the plurality of written pieces based on the determined similarities.

20. The system according to claim 19, wherein the programming instructions further comprise instructions to modify at least one electronic document based on results of the classifying.
